(19) United States
(12) Patent Application Publication
(10) Pub. No.: US 2013/0067931 A1
(43) Pub. Date: Mar. 21, 2013

(54) GAS TURBINE ENGINE ASSEMBLIES INCLUDING STRUT-BASED VIBRATION ISOLATION MOUNTS AND METHODS FOR PRODUCING THE SAME

(71) Applicants: Timothy Hindle, Peoria, AZ (US); Brian Cottrell, Litchfield Park, AZ (US); Torey Davis, Peoria, AZ (US)

(72) Inventors: Timothy Hindle, Peoria, AZ (US); Brian Cottrell, Litchfield Park, AZ (US); Torey Davis, Peoria, AZ (US)

(73) Assignee: HONEYWELL INTERNATIONAL INC., Morristown, NJ (US)

(21) Appl. No.: 13/239,115

(22) Filed: Sep. 21, 2011

(51) Int. Cl. F02C 7/20; B23P 17/00

(52) U.S. Cl. 60/797; 29/888

(57) ABSTRACT

Embodiments of a gas turbine engine assembly including a strut-based vibration isolation mount are provided, as are embodiments of a method for producing such a gas turbine engine assembly. In one embodiment, the gas turbine engine assembly includes a gas turbine engine and a vibration isolation mount. The vibration isolation mount includes, in turn, at least one three parameter axial strut having a first end attached to the gas turbine engine and having a second, opposing end configured to be attached to the airframe. The three parameter axial strut is tuned to minimize the transmission of vibrations from the gas turbine engine to the airframe during operation of the gas turbine engine.

### TECHNICAL FIELD

The present invention relates generally to gas turbine engines and, more particularly, to gas turbine engine assemblies including strut-based vibration isolation mounts, as well as to methods for producing the same.

### BACKGROUND

Modern gas turbine engine (GTE) are often equipped with relatively complex rotor assemblies including multiple coaxial, gear-linked shafts supportive of a number of compressors, air turbines, and, in the case of turbofan engines, a relatively large intake fan. During high speed rotation of the rotor assembly, vibrations originating from rotor imbalances, bearing imperfections, de-stabilizing forces, and the like may be transmitted through the rotor bearings, to the engine case, and ultimately to the aircraft fuselage. Rotor-emitted vibrations reach their highest amplitudes during rotor critical modes; that is, when the rotational frequency of the rotor assembly induces significant off-axis motion of the rotor assembly due to, for example, deflection or bending of the rotor assembly spool (referred to as “critical flex modes”) or rotor bearings eccentricies (referred to as “rigid body critical modes”). High amplitude vibrations transmitted to the aircraft fuselage can become both physically and acoustically perceptible to passengers and may consequently detract from passenger comfort. Vibrations transmitted from the aircraft fuselage to the GTE can also reduce the operational lifespan of the engine components and degrade various measures of engine performance, such as thrust output and fuel efficiency.

To minimize the transmission of vibratory forces to and from a GTE, engine manufacturers and airfamers have recently began incorporating viscoelastic isolators into conventional engine mount designs. Advantageously, the incorporation of one or more viscoelastic isolators can typically be accomplished with relatively minor modifications to a pre-existing engine mount. This notwithstanding, viscoelastic engine mounts remain limited in several respects. First, viscoelastic isolators are two parameter devices, which provide high performance damping only over relatively narrow frequency bands. Thus, while a viscoelastic isolator can be tuned to significantly reduce transmissibility at a single, targeted rotor critical mode, the viscoelastic isolator will provide less-than-optimal damping at other operational frequencies and through other rotor critical modes. A viscoelastic isolator also typically deflects in multiple degrees of freedom rendering an engine mount incorporating multiple viscoelastic isolators difficult to tune in multiple dimensions with a high degree of accuracy. Furthermore, as the stiffness and damping profiles of a viscoelastic isolator are inexorably linked, it can be difficult to optimize the damping characteristics of the viscoelastic isolators without simultaneously reducing stiffness of the engine mount. As a still further limitation, the operational lifespan of a viscoelastic isolator is typically undesirably brief due to the sensitivity of the isolator's rubber components to elevated operating temperatures and high levels of radiation encountered at flight altitudes. Finally, both viscoelastic engine mounts and conventional undamped engine mounts typically have highly cantilevered designs, which tend to transmit significant bending forces to the engine mount and airframe during GTE operation. While the engine mount and airframe can be oversized to accommodate such bending forces, this results in mass inefficiencies in engine mount and airframe design.

It is thus desirable to provide embodiments of a gas turbine engine assemblies including a vibration isolation mount, which overcomes many, if not all, of the above-noted disadvantages. In particular, it would be desirable to provide embodiments of an engine isolation mount having damping and stiffness profiles, which are independently tunable in six degrees of freedom to provide high fidelity damping of engine-emitted vibrations tailored to a particular gas turbine engine. It would also be desirable to provide embodiments of a vibration isolation mount wherein loads are generally introduced into the airframe along axial and localized transmission paths to minimize bending forces and thereby allow improvements in the mass efficiency of the engine mount and airframe. Lastly, it would also be desirable to provide embodiments of a method for producing a gas turbine engine including such a vibration isolation mount. Other desirable features and characteristics of embodiments of the present invention will become apparent from the subsequent Detailed Description and the appended Claims, taken in conjunction with the accompanying drawings and the foregoing Background.

### BRIEF SUMMARY

Embodiments of a gas turbine engine assembly including a strut-based vibration isolation mount are provided. In one embodiment, the gas turbine engine assembly includes a gas turbine engine and a vibration isolation mount. The vibration isolation mount includes, in turn, at least one three parameter axial isolator having a first end attached to the gas turbine engine and having a second, opposing end configured to be attached to the airframe. The three parameter axial isolator is tuned to minimize the transmission of vibrations from the gas turbine engine to the airframe during operation of the gas turbine engine.

Embodiments of a method for producing a gas turbine engine assembly are further provided. In one embodiment, the method includes the steps of providing a gas turbine engine and attaching a plurality of three parameter axial struts to the gas turbine engine at different locations to produce a vibration isolation mount. The plurality of three parameter axial struts are individually tuned to impart the vibration isolation mount with stiffness and damping profiles varying in multiple degrees of freedom based upon the operational characteristics of the gas turbine engine.

### BRIEF DESCRIPTION OF THE DRAWINGS

At least one example of the present invention will hereinafter be described in conjunction with the following figures, wherein like numerals denote like elements, and:

FIG. 1 is an isometric view of a gas turbine engine assembly including a viscoelastic engine mount illustrated in accordance with the teachings of prior art;

FIGS. 2 and 3 are isometric and forward end views, respectively, of a gas turbine engine assembly including a strut-based vibration isolation mount, specifically a hexapod vibration isolation mount, as illustrated in accordance with an exemplary embodiment of the present invention;

FIG. 4 is a schematic diagram illustrating an exemplary three parameter axial vibration isolator or strut; and

FIG. 5 is a transmissibility plot of frequency (horizontal axis) versus gain (vertical axis) illustrating the exemplary transmissibility profile of a three parameter vibration isolator or strut as compared to the transmissibility profiles of a two parameter isolator and an undamped device.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

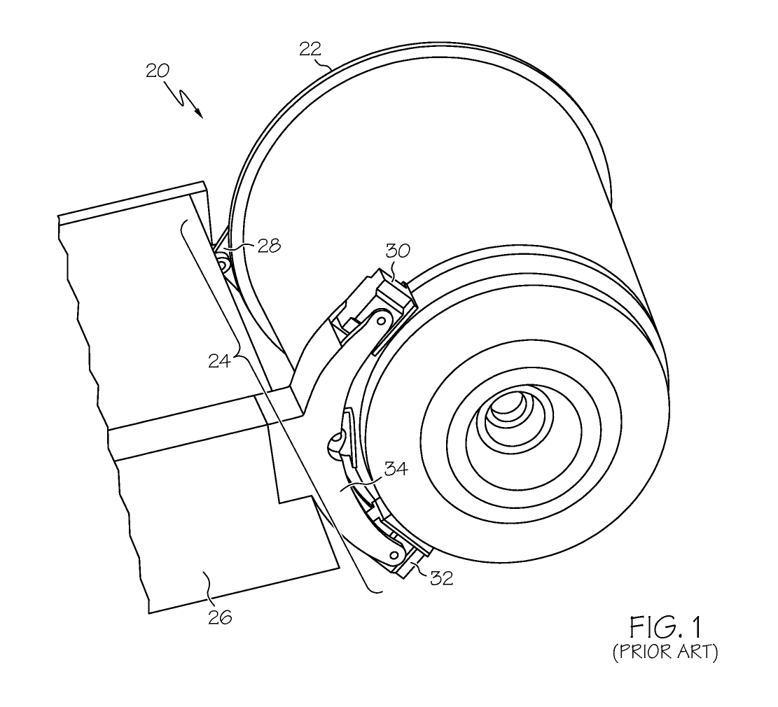

FIG. 1 is an isometric view of a gas turbine engine (GTE) assembly 20 illustrated in accordance with the teachings of prior art. GTE assembly 20 includes a viscoelastic engine mount 24 and a GTE 22, which is only partially shown in FIG. 1 for clarity. Viscoelastic engine mount 24 attaches GTE 22 to an aircraft fuselage 26 (again, only partially shown in FIG. 1) in a structurally-robust manner to transfer the relatively large thrust loads generated by GTE 22 to fuselage 26. As noted above, GTE 22 may also produce high amplitude vibrations during operation, which are ideally prevented from being transmitted to fuselage 26. To minimize the amplitude of vibrations transmitted from GTE 22 to aircraft fuselage 26, and possibly also to minimize the transmission of vibrations from fuselage 26 to GTE 22, a number of viscoelastic isolators are incorporated into engine mount 24 along one or more vibration transmission paths. In exemplary embodiment shown in FIG. 1, specifically, viscoelastic engine mount 24 includes a single aft viscoelastic isolator 28 and twin forward viscoelastic isolators 30 and 32. Aft viscoelastic isolator 28 is disposed between a rigid attachment point provided on an aft section of GTE 22 and a corresponding attachment point provided on fuselage 26. By comparison, viscoelastic isolators 30 and 32 are attached to first and second rigid attachment points provided on a forward section of GTE 22, respectively, and to opposing arms of a C-shaped yoke structure 34 affixed to aircraft fuselage 26.

Relative to a traditional, undamped engine mount, viscoelastic engine mount 24 provides improved attenuation of vibration forces transmitted between GTE 22 and aircraft fuselage 26. By reducing the amplitude of engine-emitted vibrations transmitted to fuselage 26, viscoelastic engine mount 24 decreases the likelihood that such vibrations will become perceptible to aircraft passengers and thereby helps to persevere passenger comfort. However, as generally discussed in the foregoing section entitled “BACKGROUND,” viscoelastic engine mount 24 and other such viscoelastic engine mounts are limited in several respects. For example, viscoelastic isolators 28, 30, and 32 are two parameter devices, which behave mechanically as a damper and spring in parallel. While the peak transmissibility of a two parameter isolator is significantly less than that of an undamped device or a spring in isolation, the damping profile of a two parameter device tends to decrease in gain at an undesirably slow rate after peak frequency has been surpassed. Thus, while a viscoelastic isolator may be tuned to provide peak damping at a single, targeted rotor critical mode, the viscoelastic isolator will typically provide less-than-optimal damping at other operational frequencies and through other rotor critical modes, as well as provide less attenuation of imbalance forces at operating speeds. As an additional limitation, viscoelastic isolators 28, 30, and 32 each provide damping and stiffness in multiple degrees of freedom (DOFs). It can thus be highly difficult to tune a given viscoelastic isolator to provide optimal damping and stiffness in a particular DOF without simultaneously affecting the damping and stiffness of viscoelastic engine mount 24 in one or more additional DOFs. Furthermore, the stiffness and damping profiles of a viscoelastic isolator are inexorably linked and cannot be individually tuned; consequently, it can be difficult to optimize the damping and stiffness characteristics of viscoelastic isolators 28, 30, and 32 without simultaneously changing the stiffness and damping of mount 24 in an undesired manner. As a further drawback, viscoelastic isolators 28, 30, and 32 may have an undesirably brief operational lifespan due to the radiation-sensitivity of rubber and, specifically, due to the tendency of rubber to dry rot when continually exposed to the high levels of radiation present at flight altitudes and to the high operating temperatures. Finally, as a still further limitation, viscoelastic engine mount 24 and other conventional engine mounts typically having highly cantilevered designs, which imparts significant bending forces to the airframe during engine operation. The airframe and the engine mount are generally required to be reinforced or otherwise oversized to accommodate these bending forces, which reduces the overall of mass efficiency of the airframe and engine mount.

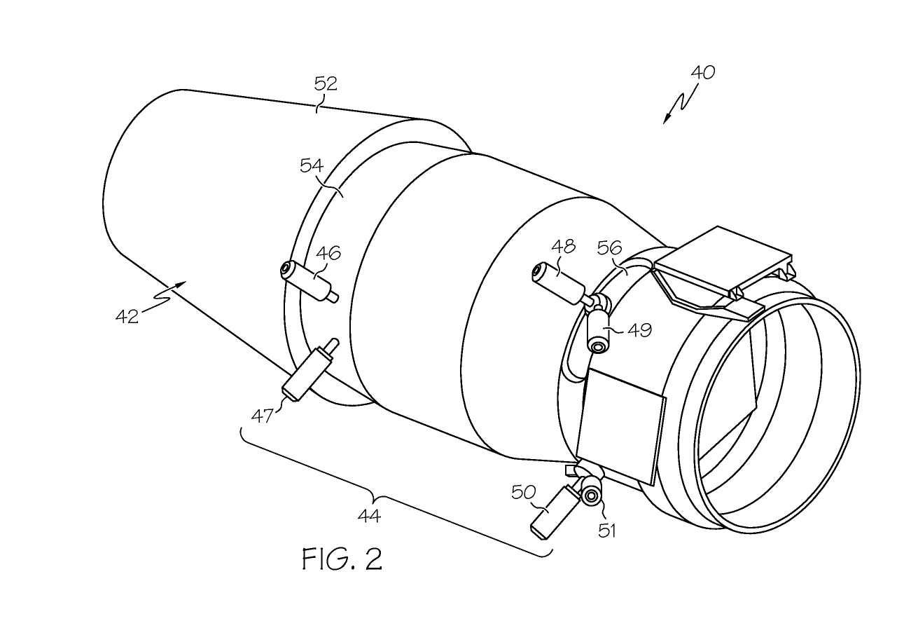

The following provides exemplary embodiments of a GTE assembly including a strut-based vibration isolation mount, which overcomes the various limitations pointed-out above in conjunction with conventional undamped and viscoelastic engine mounts. As will be described more fully below, embodiments of the vibration isolation mount include multiple axial damping members or struts, which are passive and tuned to provide optimal damping and support of a gas turbine engine in multiple degrees of freedom. In preferred embodiments, the vibration isolation mount includes three parameter axial isolators or struts, which have independently-tunable stiffness and damping characteristics and consequently can be specifically tuned to provide optimal stiffness and damping in each degree of freedom to minimize high frequency vibration transmittance from the gas turbine engine to the airframe during engine operation. Additionally, to further optimize stiffness and damping in each DOF, the struts can be arranged in a non-symmetrical configuration. The number of vibration struts employed in the high fidelity vibration isolation mount and the locations at which the axial struts are attached to the gas turbine engine will vary. In certain embodiment, the vibration isolation mount may include less than six struts in combination with various other structural elements commonly utilized to produce engine mounts. However, in preferred embodiments, the vibration isolation mount will include at least six axial struts positioned so as to fully support the gas turbine engine in six degrees of freedom. For example, in certain embodiments six struts may be combined in a hexapod configuration to minimize coupling between DOFs and thereby enable minimal engine rotation for a given linear translation or deflection while optimizing damping performance and mass efficiency. An example of such a hexapod vibration isolation mount is described more fully below in conjunction with FIGS. 2 and 3. In further embodiments, more than six struts may be included within the vibration isolation mount to provide redundancy in the event of failure; e.g., eight axial struts may be positioned in an octopod configuration to provide redundancy and to improve performance under constrained mounting conditions.

FIGS. 2 and 3 are isometric and forward end views, respectively, of a gas turbine engine (GTE) assembly 40 illustrated in accordance with an exemplary embodiment of the present invention. GTE assembly 40 includes a gas turbine engine 42 and a strut-based vibration isolation mount 44. Strut-based vibration isolation mount 44 includes a plurality of axial struts 46-51, which are coupled between GTE 42 and an airframe (not shown) at a plurality of locations. More specifically, the innermost ends of struts 46-51 are each attached to a plurality of hard mount points provided on GTE 42 (described below), while the opposing ends of struts 46-51 project radially outward for attachment to an airframe, such as airframe 26 shown in FIG. 1. The radially-outer ends of struts 46-51 may be directly attached to the airframe or, instead, indirectly attached to the airframe through a wing or other intervening structure. In the illustrated embodiment, strut-based vibration isolation mount 44 includes six struts 46-51, which are spaced about GTE 42 in a hexapod mounting arrangement. For this reason, strut-based vibration isolation mount 44 will be referred to hereafter as “hexapod vibration isolation mount 44”; however, as previously stated, vibration isolation mount 44 may include a different number of struts in alternative embodiments, which may be arranged to produce other types of high fidelity, six-DOF isolation platforms.

In the illustrated exemplary embodiment shown in FIGS. 2 and 3, and as can be seen most easily in FIG. 2, the innermost ends of struts 46 and 47 are attached to two different, circumferentially-spaced hard mount points provided on an intermediate section of outer engine housing 52 and, specifically, to a hard mount point provided on an intermediate thrust ring 56. The inner ends of struts 48 and 49, by comparison, are attached to a single hard mount pointed on a forward section of outer engine housing 52 and, specifically, to a first hard mount point provided on a forward thrust ring 56. Lastly, the inner ends of struts 50 and 51 are likewise attached to a single hard mount pointed on a forward section of outer engine housing 52 and, specifically, to a second hard mount point provided on forward thrust ring 56. The foregoing example notwithstanding, the particular spatial arrangement of struts 46-51 will vary amongst embodiments and, as indicated above, will generally be arranged to minimize coupling between DOFs to minimize engine rotation for a given linear translation or deflection. Furthermore, while in the illustrated example, struts 46-51 can be mounted to GTE 42 utilizing various other types of mounting interface structures (e.g., a plurality of brackets) in alternative embodiments. In contrast to viscoelastic elements, struts 46-51 can typically be attached to the gas turbine engine with minimal cut-outs or other modifications to the outer structures of the engine.

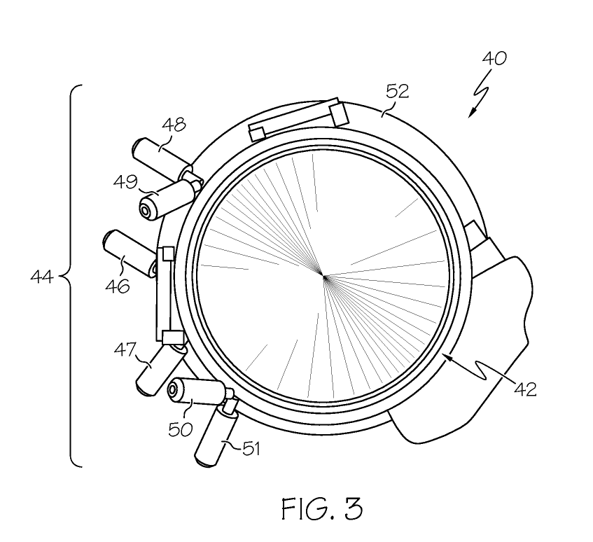

As noted above, struts 46-51 each assume the form of a three parameter axial strut or isolator. As schematically illustrated in FIG. 4, each three parameter axial strut 46-51 includes the following mechanical elements: (i) a first spring member K_{A}, which is coupled between a gas turbine engine E (e.g., GTE 42 shown in FIGS. 2 and 3) and an airframe AF (e.g., airframe 26 shown in FIG. 1); (ii) a second spring member K_{B}, which is coupled between the engine E and airframe AF in parallel with first spring member K_{A}; and (iii) a damper C_{A}, which is coupled between the engine E and airframe AF in parallel with the first spring member K_{A} and in series with the second spring member K_{B}. Such a three parameter device can be tuned to provide superior damping characteristics (i.e., a lower overall transmissibility) as compared to undamped devices and two parameter devices over a given frequency range. Transmissibility may be expressed by the following equation:

$$T ( ω ) = \frac{{X}_{output} ( ω )}{{X}_{input} ( ω )} \qquad EQ . 1$$

wherein T(ω) is transmissibility, Xᵢₙₚᵤₜ(ω) is the base input motion applied to the three parameter axial strut by the vibrating gas turbine engine E, and Xₒᵤₜₚᵤₜ(ω) is the output motion transmitted to the airframe AF through the strut. It will further be noted that struts 46-51 will also attenuate vibratory forces transmitted from the airframe AF to the engine E in certain instances. In such instances, the input motion will be the motion applied to the three parameter axial strut by the airframe AF, and the output motion will be the resultant motion imparted to engine E through the strut.

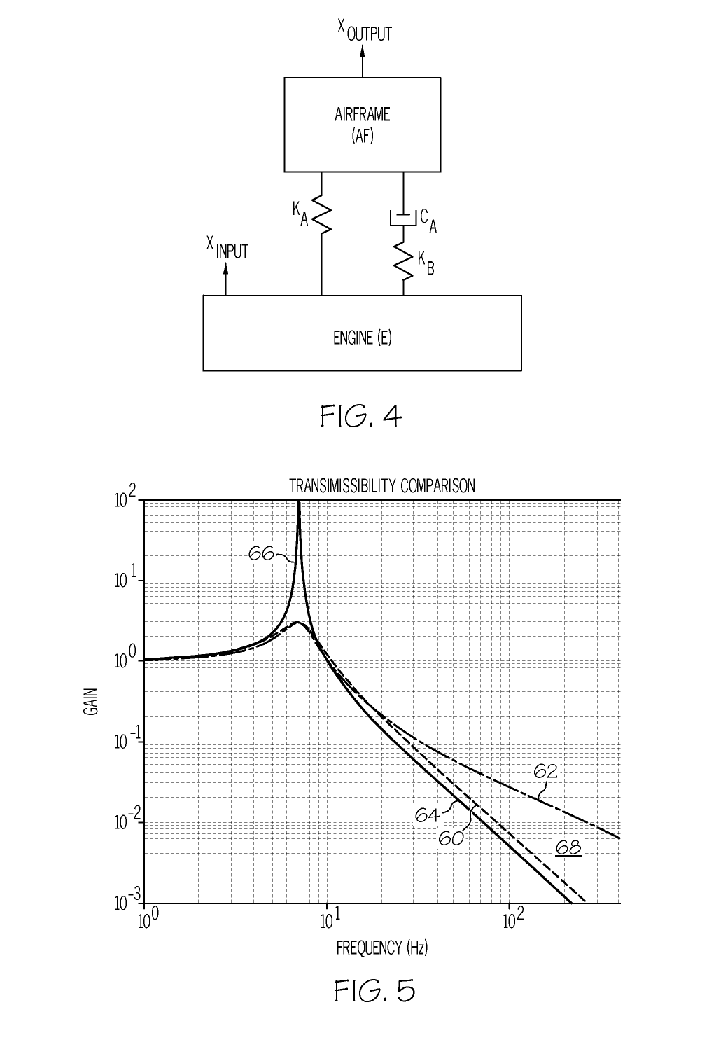

As noted above, a three parameter isolator or strut can be tuned to provide superior damping characteristics (i.e., a lower overall transmissibility) as compared to undamped devices and two parameter devices over a given frequency range. This may be more fully appreciated by referring to FIG. 5, which is a transmissibility plot illustrating the damping characteristics of three parameter axial strut (curve 60) as compared to a two parameter isolator (curve 62) and an undamped device (curve 64). As indicated in FIG. 5 at 66, the undamped device (curve 64) provides a relatively high peak gain at a threshold frequency, which, in the illustrated example, is moderately less than 10 hertz. By comparison, the two parameter device (curve 62) provides a significantly lower peak gain at the threshold frequency, but an undesirably gradual decrease in gain with increasing frequency after the threshold frequency has been surpassed (referred to as “roll-off”). In the illustrated example, the roll-off of the two parameter device (curve 62) is approximately 20 decibel per decade (“dB/decade”). Lastly, the three parameter device (curve 60) provides a low peak gain substantially equivalent to that achieved by the two parameter device (curve 62) and further provides a relatively steep roll-off of about 40 dB/decade. The three parameter device (curve 60) thus provides a significantly lower transmissibility at higher frequencies, as quantified in FIG. 5 by the area 68 bounded by curves 60 and 62. By way of non-limiting example, further discussion of three parameter axial struts can be found in U.S. Pat. No. 5,332,070, entitled “THREE PARAMETER VISCOUS DAMPER AND ISOLATOR,” issued Jan. 26, 1994; and U.S. Pat. No. 7,182,188 B2, entitled “ISOLATOR USING EXTERNALLY PRESSURIZED SEALING BELLOWS,” issued Feb. 27, 2007; both of which are assigned to assignee of the instant application. A commercially-available three parameter axial strut is the D-STRUT® isolator developed and marketed by Honeywell, Inc., currently headquartered in Morristown, N.J.

By tuning struts 46-51 to provide peak damping at frequencies generally corresponding to one or more engine critical modes, hexapod vibration isolation mount 44 can provide high fidelity damping performance over the entire dynamic operating range (static to very high frequency) of GTE 42. In particular, struts 46-51 may be specifically tuned to provide high damping of rigid body modes; that is, each strut 46-51 can be tuned to provide peak damping at resonant frequencies of GTE 42. It many cases it is advantageous to place the six-DOF modes close together in frequency such that struts 46-51 provide a high level of vibration attenuation at a targeted frequency and then rapidly roll-off substantially in unison. Furthermore, as previously stated, struts 46-51 are positioned around GTE 42 to isolate the different degrees of freedom along which vibrations and loads are transmitted from GTE 42 to the airframe. This, along with the substantial linear stiffness and damping profiles of struts 46-51, greatly simplifies tuning of hexapod vibration isolation mount 44 by enabling vibration and loads transmitted along a given path to be isolated and targeted by tuning a single three parameter axial strut. In addition, as each strut 46-51 provides axial damping in essentially a single degree of freedom, struts 46-51 can be individually tuned to collectively impart mount 44 with stiffness profiles that vary in multiple degrees of freedom to better accommodate the operational characteristics of GTE 42. For example, as disturbances emitted from GTE 42 are primarily transmitted in radial directions as opposed to axial directions, struts 46-51 can be tuned to have a relatively high radial compliance and thus provide a relatively high level of attenuation in radial directions, while being relatively stiff and providing less attenuation in longitudinal or axial directions.

As three parameter devices, struts 46-51 can be individually tuned to impart hexapod vibration isolation mount 44 with stiffness and damping profiles that vary in different DOFs. This allows displacement of GTE 52 to be minimized and improvements in thrust vector stability to be achieved. As GTE 42 will produce relatively large thrust loads (e.g., approach or exceeding about 7500 pound-force) during operation, struts 46-51 are advantageously tuned to have a relatively high longitudinal or axial stiffness in the thrust load direction; that is, three parameter axial struts 46-51 may be tuned to impart vibration isolation mount 44 with a maximum stiffness in the thrust load direction. Struts 46-51 may further be tuned to provide with a minimum stiffness in at least one radial direction. In addition, struts 46-51 may be tuned to impart isolation mount 44 with a relatively high stiffness in the vertical support direction to counteract gravity sag that may otherwise be caused by the weight of GTE 42. The vertical support stiffness is preferably less than the maximum stiffness provided in the thrust direction and less than the minimum stiffness provided in one or more radial directions. In still further embodiments, three parameter axial struts 46-51 may be tuned to impart isolation mount 44 with controlled stiffnesses tailored to counteract maneuver loads and gyroscopic forces that may occur during operation of GTE 42. In certain embodiments, the arrangement of axial struts 46-51 within the hexapod may be non-symmetrical to more closely tailor the desired stiffness and damping properties of mount 44 to GTE 42, which may have mass/inertia properties and operational structural requirements that may likewise be asymmetrical in three dimensional space.

In addition to providing independently tunable damping and stiffness profiles, hexapod vibration isolation mount 44 is also highly mass efficient. In particular, hexapod vibration isolation mount 44 is able to restrict the transmission of loads to primarily axial paths with minimal eccentricities (i.e., axial loads are transmitted to the airframe in a highly localized manner) thereby minimizing bending forces and reducing stress concentrations within mount 44 and the airframe to which mount 44 is joined. As a result, the overall mass of the mount and airframe can be reduced, and a significant weight savings can be realized. Stated differently, the mass associated with both the engine mount and airframe design can be reduced via an optimization in load path design to produce a system providing superior performance from both a mass efficiency standpoint and from a vibration isolation standpoint, as well (via lower vibration transmitted to the airframe). As a further and related advantage, isolation mount 44 also reduces loading between GTE 42 and the airframe due to thermal gradients, which may develop during high temperature operation of GTE 42 between GTE 42 and the cooler airframe to which isolation mount 44 is attached.

The foregoing has provided embodiments of a gas turbine engine assembly including a strut-based vibration isolation mount, such as a hexapod vibration isolation mount, which significantly reduces the transmission of vibrations from a gas turbine engine to an aircraft fuselage. In particular, the foregoing has provided embodiments an engine isolation mount having damping and stiffness profiles, which are independently tunable in six degrees of freedom to provide high fidelity damping of engine-emitted vibrations tailored to a particular gas turbine engine. Embodiments of the above-described vibration isolation mount also introduce loads into the airframe in a highly axial and localized manner to minimize bending forces and thereby allow the mass efficiency of the engine mount and airframe to be optimized as compared to conventional cantilevered engine mount designs. While in the above-described exemplary embodiment six axial struts were combined in a hexapod arrangement, further embodiments of the vibration isolation mount may include fewer or a greater number of axial struts; e.g., in certain embodiments, vibration isolation mount may include eight axial struts combined in an octopod configuration.

While primarily described above in the context of a functioning system or apparatus, the foregoing has also provided embodiments of a method for producing a gas turbine engine assembly including such a high fidelity vibration isolation mount. In certain embodiments, the above-described method included the steps of providing a gas turbine engine, attaching a plurality of three parameter axial struts to the gas turbine engine at different locations to produce a vibration isolation mount, and independently tuning the plurality of three parameter axial struts to impart the vibration isolation mount with stiffness and damping profiles varying in multiple degrees of freedom based upon the operational characteristics of the gas turbine engine. The step of attaching may entail arranging six three parameter axial struts about the gas turbine engine to produce a hexapod vibration isolation mount or, instead, arranging eight three parameter axial struts about the gas turbine engine to produce an octopod vibration isolation mount. During the step of independently tuning, the three parameter axial struts may be specifically tuned to impart the hexapod vibration isolation mount with: (i) a maximum stiffness in the thrust load direction, (ii) a minimum stiffness in at least one radial direction, and/or (iii) a stiffness in the vertical support direction greater than the minimum stiffness and less than the maximum stiffness.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A gas turbine engine assembly mountable to an airframe, the gas turbine engine assembly comprising:
a gas turbine engine; and
a vibration isolation mount comprising at least one three parameter axial strut having a first end attached to the gas turbine engine and having a second, opposing end configured to be attached to the airframe, the at least one three parameter axial strut tuned to minimize the transmission of vibrations from the gas turbine engine to the airframe during operation of the gas turbine engine.

2. A gas turbine engine assembly according to claim 1 wherein vibration isolation mount comprises a plurality of three parameter axial struts attached to the gas turbine engine at a plurality of different locations and projecting radially outward therefrom.

3. A gas turbine engine assembly according to claim 2 wherein the vibration isolation mount comprises six three parameter axial struts spaced about the gas turbine engine in a hexapod configuration.

4. A gas turbine engine assembly according to claim 2 wherein the plurality of three parameter axial struts is tuned to impart the vibration isolation mount with a stiffness varying in multiple degrees of freedom.

5. A gas turbine engine assembly according to claim 4 wherein the plurality of three parameter axial struts is tuned to impart the vibration isolation mount with a maximum stiffness in the thrust load direction.

6. A gas turbine engine assembly according to claim 5 wherein the plurality of three parameter axial struts is tuned to impart the vibration isolation mount with a minimum stiffness in at least one radial direction.

7. A gas turbine engine assembly according to claim 6 wherein the plurality of three parameter axial struts is tuned to impart vibration isolation mount with a stiffness in the vertical support direction exceeding the minimum stiffness.

8. A gas turbine engine assembly according to claim 7 wherein the plurality of three parameter axial struts is tuned to impart vibration isolation mount with a stiffness in the vertical support direction less than the maximum stiffness.

9. A gas turbine engine assembly according to claim 2 wherein the plurality of three parameter axial struts is tuned to impart the vibration isolation mount with a damping profile varying in multiple degrees of freedom.

10. A gas turbine engine assembly according to claim 9 wherein the plurality of three parameter axial struts is tuned to impart the vibration isolation mount with a transmissibility in each radial direction that is less than the transmissibility of the vibration isolation mount in either axial direction.

11. A gas turbine engine assembly configured to be mounted to an airframe, the gas turbine engine assembly comprising:
a gas turbine engine; and
a vibration isolation mount comprising at least six axial struts attached to the gas turbine engine at a plurality of mount points, each of the six axial struts independently tuned to impart the vibration isolation mount with stiffness and damping profiles varying in multiple degrees of freedom.

12. A gas turbine engine assembly according to claim 11 wherein the at least six axial struts comprises six three parameter axial struts arranged about the gas turbine engine to produce a hexapod vibration isolation mount.

13. A gas turbine engine assembly according to claim 12 wherein the plurality of three parameter axial struts is tuned to impart the hexapod vibration isolation mount with stiffness and damping profiles varying in multiple degrees of freedom.

14. A gas turbine engine assembly according to claim 13 wherein the plurality of three parameter axial struts is tuned such that stiffness of the vibration isolation mount in the vertical support direction and in the thrust load direction exceeds the stiffness of the hexapod vibration isolation mount in lateral directions.

15. A gas turbine engine assembly according to claim 13 wherein the plurality of three parameter axial struts is tuned such that transmissibility of the hexapod vibration isolation mount in each radial direction is less than the transmissibility of the vibration isolation mount in either axial direction.

16. A method for producing a gas turbine engine assembly, comprising:
providing a gas turbine engine;
attaching a plurality of three parameter axial struts to the gas turbine engine at different locations to produce a vibration isolation mount; and
independently tuning the plurality of three parameter axial struts to impart the vibration isolation mount with stiffness and damping profiles varying in multiple degrees of freedom based upon the operational characteristics of the gas turbine engine

17. A method according to claim 16 wherein the step of attaching comprises one of the group consisting of arranging six three parameter axial struts about the gas turbine engine to produce a hexapod vibration isolation mount, and arranging eight three parameter axial struts about the gas turbine engine to produce an octopod vibration isolation mount.

18. A method according to claim 17 wherein the step of independently tuning comprises independently tuning the plurality of three parameter axial struts to impart the hexapod vibration isolation mount with a maximum stiffness in the thrust load direction.

19. A gas turbine engine assembly according to claim 18 wherein the step of independently tuning comprises independently tuning the plurality of three parameter axial struts to further impart the hexapod vibration isolation mount with a minimum stiffness in at least one radial direction.

20. A gas turbine engine assembly according to claim 19 wherein the step of independently tuning comprises independently tuning the plurality of three parameter axial struts to further impart the hexapod vibration isolation mount with a stiffness in the vertical support direction greater than the minimum stiffness and less than the maximum stiffness.
